(19) United States
(12) Patent Application Publication
(10) Pub. No.: US 2020/0016890 A1
(43) Pub. Date: Jan. 16, 2020

(54) IMAGE FORMING APPARATUS, IMAGE FORMING METHOD, CORRECTION VALUE CALCULATING PROGRAM, AND CORRECTION VALUE DETECTION PATTERN

(71) Applicant: Konica Minolta, Inc., Tokyo (JP)

(72) Inventor: Shinya ASAKURA, Kawasaki-shi (JP)

(21) Appl. No.: 16/409,540

(22) Filed: May 10, 2019

(30) Foreign Application Priority Data
Jul. 13, 2018 (JP) 2018-132879

(51) Int. Cl. B41J 2/045

(52) U.S. Cl. CPC B41J 2/04541; B41J 2/04586

(57) ABSTRACT

There is provided an image forming apparatus capable of forming a correction value detection pattern in order to accurately correct an ink landing displacement cyclically occurring due to the driving of a media transporting apparatus. The image forming apparatus includes the media transporting apparatus, an ink supply apparatus, an encoder, a first clock signal generator, a second clock signal generator, and a drive signal generator, in which the drive signal generator includes a first driving circuit and a second driving circuit to generate a drive signal in order to control discharge of ink from ink discharge nozzles in a first nozzle group and a second nozzle group independently of each other on a group basis, and the ink supply apparatus forms the correction value detection pattern on the recording medium transported by the media transporting apparatus.

### CROSS-REFERENCE TO RELATED APPLICATIONS

The entire disclosure of Japanese Patent Application No. 2018-132879, filed on Jul. 13, 2018, is incorporated herein by reference in its entirety.

### BACKGROUND

### Technological Field

The present invention relates to an image forming apparatus, an image forming method, a correction value calculating program, and a correction value detection pattern.

### Description of the Related art

An ink jet image forming apparatus includes a recording medium transporting apparatus and an ink head that discharges ink onto a recording medium transported by the transporting apparatus. The image forming apparatus causes displacement of ink landing positions on a recording medium due to the eccentricity of a roller drive shaft included in the transporting apparatus, variations of a drive shaft diameter due to thermal expansion, or an eccentricity component such as installation accuracy of an encoder installed on the roller to generate a print clock. The print clock is corrected in order to prevent the displacement of ink landing positions. The following technologies are disclosed for the correction.

As described in Patent Literature 1, for example, a detection pattern is printed based on an uncorrected print clock. A line sensor reads the printed displacement detection pattern. Read image data is used to compare an interval between displacement detection patterns printed at adjacent positions with the design value for an interval between displacement detection patterns. The print clock is corrected based on a displacement amount.

As described in Patent Literature 2, the drive amount of a transport belt is acquired by counting pulse edges in an encoder signal supplied from an encoder. The transport amount of paper is detected from a difference in two-dimensional image data chronologically acquired by an image sensor. Based on the drive amount and the transport amount, a pulse cycle is corrected during generation of a discharge timing signal from the encoder signal.

### CITATION LIST

### Patent Literature

Patent Literature 1: JP 2008-110572 A

Patent Literature 2: JP 2016-182694 A

### SUMMARY

However, the ink jet image forming apparatus is subject to displacement of ink landing positions due to not only an eccentricity component described above but also variations in a transportation speed of recording media. The displacement due to variations in the transportation speed irregularly occurs and therefore constitutes an error component for the cyclic displacement that occurs depending on the roller eccentricity.

The technology described in the above-described patent literature corrects a print clock based on the formed displacement detection pattern containing the displacement as an error component caused by variations in the transportation speed. Therefore, it has been impossible to accurately correct the ink landing position displacement that cyclically occurs due to an eccentricity component.

It is an object of the present invention to provide an image forming apparatus capable of forming a correction value detection pattern in order to accurately correct an ink landing displacement cyclically occurring due to the driving of a media transporting apparatus and to provide an image forming method and a correction value calculating program capable of highly accurately correcting the displacement of an ink landing position. It is another object of the present invention to provide a correction value detection pattern capable of accurately correcting the ink landing displacement cyclically occurring due to the driving of a transporting apparatus in the image forming apparatus.

To achieve at least one of the above-mentioned objects, according to an aspect of the present invention, there is provided an image forming apparatus including a media transporting apparatus, an ink supply apparatus, an encoder, a first clock signal generator, a second clock signal generator, and a drive signal generator. The media transporting apparatus transports a recording medium. The ink supply apparatus includes a plurality of ink discharge nozzles in a direction orthogonal to a transportation direction of the recording medium transported by the media transporting apparatus. The encoder is provided for the media transporting apparatus in order to detect a transport amount of the recording medium and acquire a pulse signal as a reference of ink discharge from the ink discharge nozzle. The first clock signal generator outputs a pulse signal output from the encoder as a first clock signal at a timing corresponding to the transportation of the recording medium. The second clock signal generator outputs a pulse signal having a specified interval as a second clock signal at a timing corresponding to the transportation of the recording medium. The drive signal generator generates a drive signal to control the discharge of ink from the ink discharge nozzle. The drive signal generator includes a first driving circuit and a second driving circuit to generate a drive signal in order to control discharge of ink from ink discharge nozzles in a first nozzle group and a second nozzle group independently of each other on a group basis, the first nozzle group and the second nozzle group being provided by dividing a placement of ink discharge nozzles into two in a direction orthogonal to a transportation direction of the recording medium. The first driving circuit generates a drive signal that discharges ink from an ink discharge nozzle in the first nozzle group at an interval of the first clock signal. The second driving circuit generates a drive signal that discharges ink from an ink discharge nozzle in the second nozzle group at an interval of the second clock signal. The ink supply apparatus forms a correction value detection pattern on the recording medium transported by the media transporting apparatus, the correction value detection pattern including a first chart having lines placed at an interval of the first clock signal and a second chart having lines placed at an interval of the second clock signal according to the ink discharge from ink discharge nozzles in the first nozzle group and the second nozzle group based on the drive signal generated from the first driving circuit and the second driving circuit.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram illustrating an image forming apparatus according to an embodiment;

FIG. 2 is a bottom view illustrating a head unit provided for the image forming apparatus according to the embodiment;

FIG. 3 is a block diagram illustrating the image forming apparatus according to the embodiment;

FIG. 4 is a block diagram illustrating major parts of the image forming apparatus according to the embodiment;

FIG. 5 is a block diagram illustrating normal printing in the image forming apparatus according to the embodiment;

FIG. 6 is a block diagram illustrating the formation of a correction value detection pattern in the image forming apparatus according to the embodiment;

FIG. 7 is a diagram illustrating a correction value detection pattern used to explain an image forming method according to the embodiment;

FIG. 8 is a diagram illustrating in detail the correction value detection pattern;

FIG. 9 is a graph illustrating the displacement amount of ink landing positions;

FIG. 10 is a diagram illustrating the irregular displacement of ink landing positions occurring due to a variation in a transportation speed;

FIG. 11 is a diagram illustrating a correction table to correct a signal based on a phase-A signal of an encoder;

FIG. 12 is a diagram illustrating displacement of a correction signal that has completed eccentricity correction; and

FIG. 13 is a block diagram illustrating a first modification of the embodiment.

### DETAILED DESCRIPTION OF EMBODIMENTS

The description below explains the embodiment of an image forming apparatus, an image forming method, and an image forming program according to the present invention. However, the scope of the invention is not limited to the disclosed embodiment.

### Image Forming Apparatus

FIG. 1 is a configuration diagram illustrating an image forming apparatus 1 according to the embodiment. FIG. 1 contains a side view (A) viewed from the side of an image former in the ink-jet image forming apparatus 1 and a top view (B) viewed from the top of the same. As illustrated in the diagrams, the ink jet image forming apparatus 1 according to the first embodiment includes a media transporting apparatus 1a, a media passage sensor 1b, an ink supply apparatus 1c, and a control apparatus 1d. The image forming apparatus 1 further includes a correction table generation apparatus 1e that may be provided as an external apparatus. These are configured as follows.

### Media Transporting Apparatus 1a

The media transporting apparatus 1a transports recording medium P in a specified direction. The media transporting apparatus 1a is provided as a belt transporting apparatus, for example, and includes a driving roller 11, a driven roller 12, and an endless belt 13 tensioned over these. The driving roller 11 rotates to circulate the endless belt 13. An outer periphery of the endless belt 13 between the driving roller 11 and the driven roller 12 provides a mounting surface 13s for recording medium P. The endless belt 13 transports recording medium P supplied onto the mounting surface 13s in a circulating direction of the endless belt 13 while recording medium P is stuck on the mounting surface 13s by suction. The circulating direction of the endless belt 13 on the mounting surface 13s is hereinafter assumed to be transportation direction x of recording medium P.

An encoder 14 is provided for the driven roller 12 of the media transporting apparatus 1a. The encoder 14 is incremental and includes a phase-Z terminal 14z and a phase-A terminal 14a. The phase-Z terminal 14z outputs a phase-Z signal that occurs once each time the driven roller 12 rotates once. The phase-A terminal 14a outputs a phase-A signal that is a pulse signal corresponding to the amount of rotation of the driven roller 12. The phase-A signal provides the reference of ink discharge from a discharge nozzle of the ink supply apparatus 1c. A pulse train of the phase-A signal can use the phase-Z signal as an origin within one rotation.

### Media Passage Sensor 1b

The media passage sensor 1b detects recording medium P that is supplied to the media transporting apparatus 1a from an unshown media supplier. The media passage sensor 1b detects the passage of recording medium P by using an optical technique, for example. The media passage sensor 1b is installed at a specified position near the most upstream point along transportation direction x of recording medium P in the media transporting apparatus 1a. The media passage sensor 1b detects that the edge of recording medium P supplied to the media transporting apparatus 1a passes through a specified position.

### Ink Supply Apparatus 1c

The ink supply apparatus 1c supplies ink to recording medium P transported by the media transporting apparatus 1a. The ink supply apparatus 1c includes a plurality of head units 20 placed along transportation direction x of recording medium P.

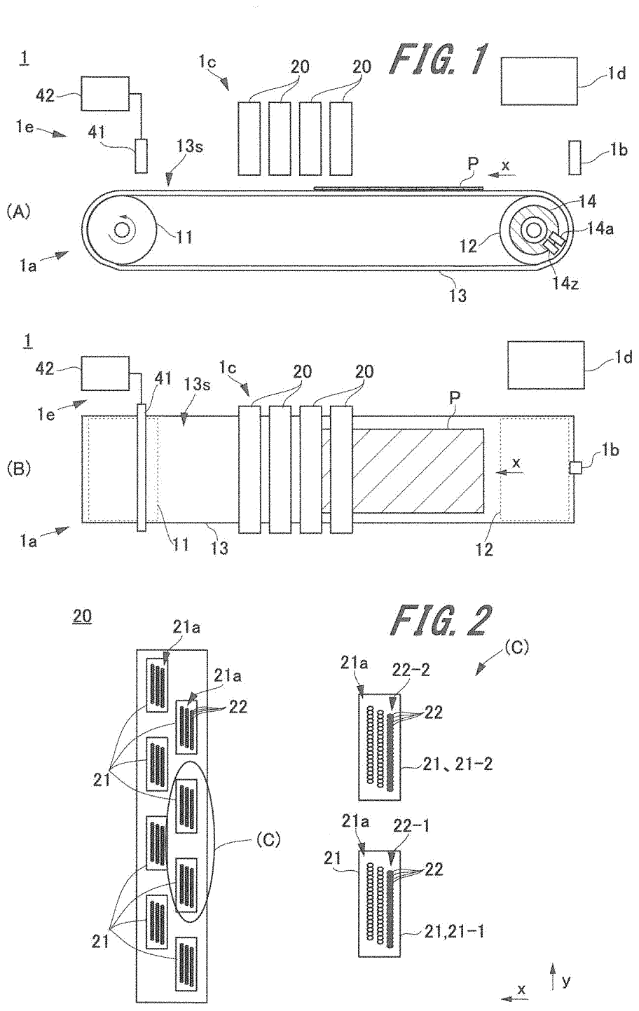

FIG. 2 is a bottom view illustrating the head unit 20 provided for the image forming apparatus according to the embodiment. FIG. 2 illustrates one of the head units 20 illustrated in FIG. 1 viewed from the side facing the media transporting apparatus 1a. FIG. 2 also includes an enlarged view (C) by partially enlarging one head unit 20.

As illustrated in FIG. 2, the head unit 20 includes a plurality of ink heads 21 placed along a bottom surface facing the media transporting apparatus 1a. When placement direction y is orthogonal to transportation direction x of recording medium P, the illustrated example forms one column of four ink heads 21 and alternately places two columns of ink heads 21 in placement direction y. Each ink head 21 includes a nozzle surface 21a that faces the media transporting apparatus 1a and contains openings of a plurality of ink discharge nozzles 22.

Each nozzle surface 21a includes a plurality of columns (three columns in the illustrated example) of the ink discharge nozzles 22 placed along placement direction y. On one nozzle surface 21a, columns of the ink discharge nozzles 22 are each displaced in placement direction y. The amount of displacement is smaller than an opening size of the ink discharge nozzle 22.

Particularly, according to the present embodiment, two ink heads 21 adjacently placed in placement direction y include ink discharge nozzles 22 that are placed on the same straight line extending in placement direction y. These ink discharge nozzles 22 are used to form a correction value detection pattern to be described later.

In the illustrated example, one head unit 20 includes two ink heads 21 that are adjacently placed at the center of placement direction y. These two ink heads 21 are denoted as a first ink head 21-1 and a second ink head 21-2 to form a correction value detection pattern.

The first ink head 21-1 and the second ink head 21-2 each include a group of ink discharge nozzles 22, namely, a first nozzle group 22-1 and a second nozzle group 22-2 that are placed on the same line extending in placement direction y. The first nozzle group 22-1 includes the ink discharge nozzles 22 provided for the first ink head 21-1. The second nozzle group 22-2 includes the ink discharge nozzles 22 provided for the second ink head 21-2. The first nozzle group 22-1 and the second nozzle group 22-2 are used to form a correction value detection pattern to be described in detail later.

### Control Apparatus 1d

The control apparatus 1d controls driving of the media transporting apparatus 1a, the ink supply apparatus 1c, the correction table generation apparatus 1e, and other unshown drive apparatuses of the image forming apparatus 1. The control apparatus 1d includes a calculator such as a microcomputer. The calculator includes a CPU (Central Processing Unit), ROM (Read Only Memory), and RAM (Random Access Memory). The calculator may also include nonvolatile storage and a network interface.

According to the present embodiment, the control apparatus 1d includes a function that corrects timing to supply ink from the ink supply apparatus 1c in synchronization with transportation by the media transporting apparatus 1a. A function provided for each part of the control apparatus 1d is available as a program saved in the ROM or a program loaded and saved in the RAM from an external apparatus. These programs constitute an image forming program executed by the computer that controls the image forming apparatus 1.

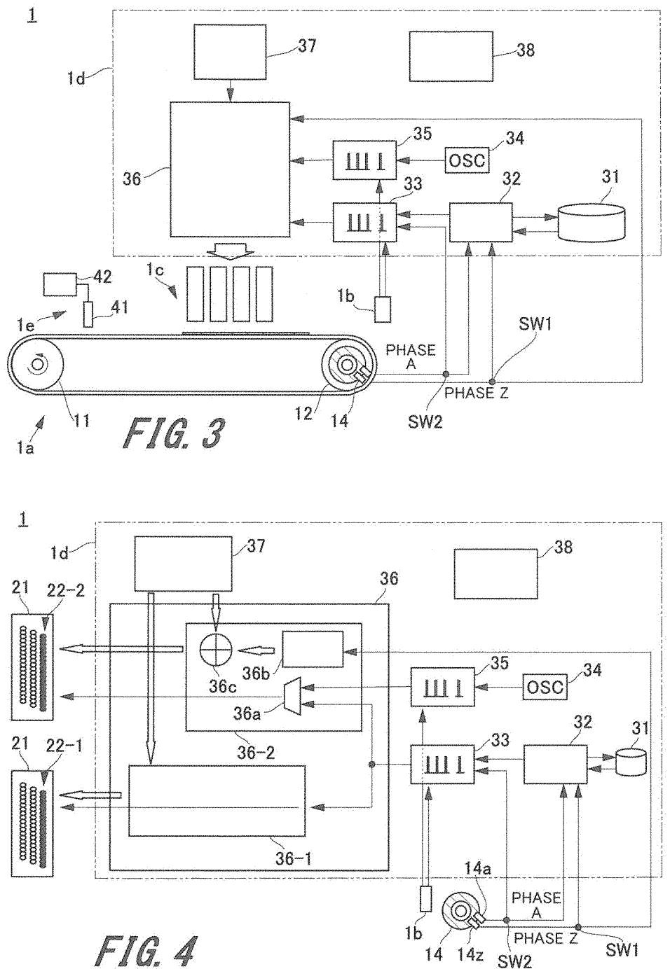

FIG. 3 is a block diagram illustrating the image forming apparatus 1 according to the embodiment and mainly illustrates the configuration of the control apparatus 1d. As illustrated in this diagram, the control apparatus 1d includes a storage 31, a signal corrector 32, a first clock signal generator 33, an internal clock generator 34, a second clock signal generator 35, a drive signal generator 36, an image data generator 37, and a controller 38. These components have functions described below. The CPU in the control apparatus 1d reads and executes a program stored in the ROM to implement the functions.

### Storage 31

The storage 31 is connected to the signal corrector 32. The storage 31 saves a correction table that corrects a pulse interval of a phase-A signal output from the encoder 14. The pulse interval of the phase-A signal output from the encoder 14 contains a cyclic error due to eccentricity components such as an installation accuracy of the encoder 14, eccentricity of the driving roller 11, and a variation of the drive shaft diameter caused by thermal expansion of the driving roller 11. The storage 31 saves the correction table comprised of correction data that cancels the cyclic error. The correction table will be described in detail later.

### Signal Corrector 32

The signal corrector 32 is connected to the phase-Z terminal 14z of the encoder 14 via a first switch SW1 and is connected to the phase-A terminal 14a of the encoder 14 via a second switch SW2. The signal corrector 32 is also connected to the storage 31 and the first clock signal generator 33.

The signal corrector 32 generates increment addresses for the correction table stored in the storage 31 with reference to the phase-Z signal output from the phase-Z terminal 14z of the encoder 14 and reads correction data from the correction table. The signal corrector 32 applies the correction data read from the storage 31 to the phase-A signal output from the phase-A terminal 14a of the encoder 14 and generates a corrected phase-A signal that is already subject to the eccentricity correction. The signal corrector 32 outputs the generated corrected phase-A signal to the first clock signal generator 33.

### First Clock Signal Generator 33

The first clock signal generator 33 is connected to the phase-A terminal 14a of the encoder 14 via the second switch SW2. The first clock signal generator 33 is also connected to the signal corrector 32, the media passage sensor 1b, and the drive signal generator 36.

The first clock signal generator 33 uses a passage signal for recording medium P input from the media passage sensor 1b as a trigger and outputs a first clock signal to the drive signal generator 36 at the timing when recording medium P reaches an ink discharge position in the ink supply apparatus 1c. Based on the operation of the second switch SW2, the first clock signal corresponds to the phase-A signal directly input from the phase-A terminal 14a of the encoder 14 or the corrected phase-A signal input from the signal corrector 32.

### Internal Clock Generator 34

The internal clock generator 34 generates a clock signal at a specified cycle as an internal clock signal. The internal clock signal configures a pulse train comparable to the design value for the phase-A signal output from the encoder 14, namely, a pulse train containing no eccentricity component. The internal clock generator 34 may be provided as an oscillation circuit such as an oscillator.

### Second Clock Signal Generator 35

The second clock signal generator 35 is connected to the internal clock generator 34, the media passage sensor 1b, and the drive signal generator 36. The second clock signal generator 35 uses a passage signal for recording medium P input from the media passage sensor 1b as a trigger and outputs a second clock signal to the drive signal generator 36 at the timing when recording medium P reaches an ink discharge position in the ink supply apparatus 1c. The second clock signal corresponds to an internal clock signal input from the internal clock generator 34.

### Drive Signal Generator 36

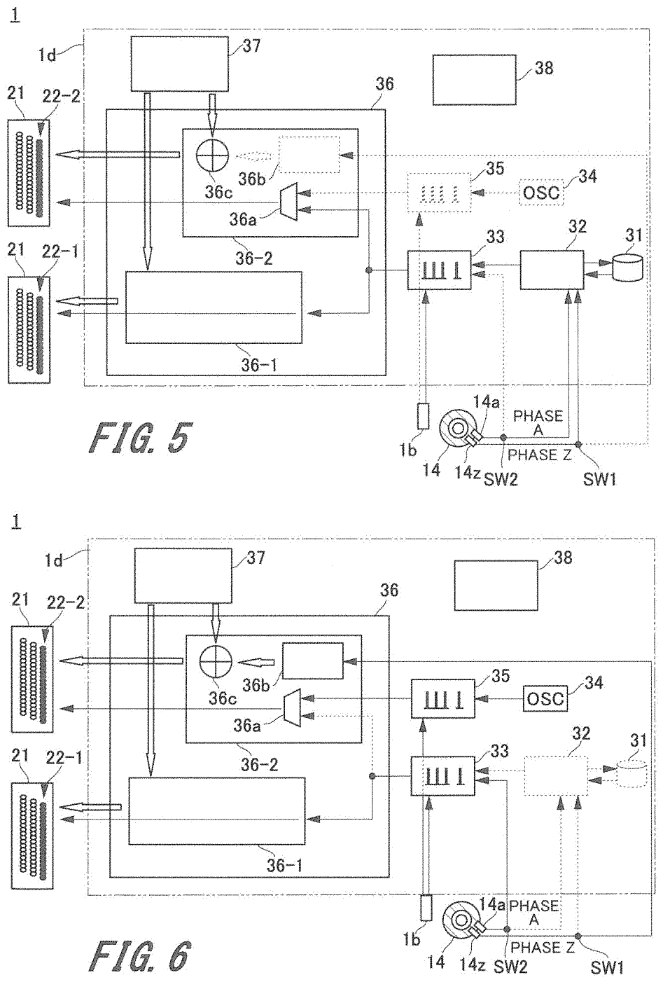

FIG. 4 is a block diagram illustrating major parts of the image forming apparatus 1 according to the embodiment and particularly illustrates the configuration of the drive signal generator 36 in detail. As illustrated in FIGS. 4 and 3, the drive signal generator 36 is connected to the phase-Z terminal 14z of the encoder 14 via the first switch SW1. The drive signal generator 36 is also connected to the first clock signal generator 33, the second clock signal generator 35, and the image data generator 37.

The drive signal generator 36 individually controls ink discharge from each ink discharge nozzle 22 of each ink head 21 based on signals input from the components. The drive signal generator 36 includes a first driving circuit 36-1 and a second driving circuit 36-2. The first driving circuit 36-1 controls the first nozzle group 22-1 and the second driving circuit 36-2 controls the second nozzle group 22-2 for a plurality of the ink discharge nozzles 22 provided for a plurality of the ink heads 21 described above.

### First Driving Circuit 36-1

The first driving circuit 36-1 is connected to the first clock signal generator 33 and the image data generator 37. The first driving circuit 36-1 reads image data from the image data generator 37 corresponding to the first clock signal input from the first clock signal generator 33. The first driving circuit 36-1 supplies each nozzle of the first nozzle group 22-1 with a head drive signal corresponding to the read image data and allows each nozzle to discharge the ink from the nozzle opening.

### Second Driving Circuit 36-2

The second driving circuit 36-2 includes a selection circuit 36a, a marker generating circuit 36b, and a signal synthesizing circuit 36c.

The selection circuit 36a is connected to the first clock signal generator 33 and the second clock signal generator 35. The selection circuit 36a selects the first clock signal from the first clock signal generator 33 or the second clock signal from the second clock signal generator 35 based on an instruction from the drive controller 38 to be described later.

The marker generating circuit 36b is connected to the phase-Z terminal 14z of the encoder 14 via the first switch SW1. The marker generating circuit 36b generates image data to form a marker corresponding to the cycle of a phase-Z signal input from the phase-Z terminal 14z.

The signal synthesizing circuit 36c is connected to the marker generating circuit 36b and the image data generator 37. The signal synthesizing circuit 36c reads image data from the image data generator 37 corresponding to a signal selected by the selection circuit 36a out of the first clock signal from the first clock signal generator 33 or the second clock signal from the second clock signal generator 35. The signal synthesizing circuit 36c synthesizes the image data for the marker generated by the marker generating circuit 36b corresponding to the cycle of the phase-Z signal with the image data read from the image data generator 37. The signal synthesizing circuit 36c supplies each nozzle of the second nozzle group 22-2 with a head drive signal corresponding to the synthesized image data and allows each nozzle to discharge ink from the nozzle opening.

### Image Data Generator 37

The image data generator 37 is connected to the drive signal generator 36. The image data generator 37 generates and holds image data to form an image on recording medium P. Particularly, the image data generator 37 generates image data to form a correction value detection pattern as well as image data to print normal images on recording medium P. These image data are generated based on an image acquired by an unshown print image acquisition part or an image input from an external apparatus. As will be described later, an image forming method covers the detailed description of the correction value detection pattern generated based on image data generated in the image data generator 37.

### Drive Controller 38

The drive controller 38 controls the driving of each component to drive the image forming apparatus 1. According to the present embodiment, the drive controller 38 is connected to the driving roller 11, the first switch SW1, and the second switch SW2 of the media transporting apparatus 1a and the selection circuit 36a of the drive signal generator 36. When the manipulation on an unshown manipulator enters an instruction to print an image, the drive controller 38 then drives the driving roller 11 of the media transporting apparatus 1a to start transporting recording medium P.

The drive controller 38 controls switching between the first switch SW1 and the second switch SW2 and controls the selection circuit 36a to select a clock signal depending on whether the specified image printing signifies normal image printing or printing of the correction value detection pattern. As will be described later, the image forming method covers the detailed description of these processes performed by the drive controller 38.

### Correction Table Generation Apparatus 1e

Returning to FIG. 3, the correction table generation apparatus 1e generates the correction table to be stored in the storage 31 based on a correction value detection pattern formed on recording medium P using the ink supplied from the ink supply apparatus 1c. The correction table generation apparatus 1e includes an image read sensor 41 and a calculator 42. These are configured as described below. The image read sensor 41 and the calculator 42 included in the correction table generation apparatus 1e are not necessarily provided for the image forming apparatus 1 but may be provided for respective external apparatuses independent of the image forming apparatus 1.

### Image Read Sensor 41

The image read sensor 41 reads an image formed on recording medium P. The image read sensor 41 may be available as an inline sensor when provided inside the image forming apparatus 1, for example. In this case, the image read sensor 41 is installed downstream of the ink supply apparatus 1c along transportation direction x for recording medium P. The image read sensor 41 may be available as a flatbed scanner when provided as an external apparatus for the image forming apparatus 1.

### Calculator 42

The calculator 42 detects a measured value (to be described) from the image read by the image read sensor 41 and calculates the correction table to be stored in the storage 31 based on the detected measured value and a design value concerning the image forming apparatus 1. The calculator 42 is configured as a counting machine such as a microcomputer. The calculator 42 may be a function included in an external apparatus outside the image forming apparatus 1. As will be described later, the image forming method covers the detailed description of a procedure to generate the correction table in the calculator 42.

### Image Forming Method

The description below explains the image forming method using the image forming apparatus 1 described above. The description first contains a procedure to perform normal printing as the image forming method using the image forming apparatus 1. The description then contains a procedure to print the correction value detection pattern in order to accurately correct an ink landing displacement and the correction value detection pattern that is formed accordingly. The description then contains a method of generating the correction table using the formed correction value detection pattern.

### Image Formation Based on Normal Printing

FIG. 5 is a block diagram illustrating normal printing in the image forming apparatus 1 according to the embodiment. A dotted line represents a constituent element that does not function in the image formation during normal printing. As illustrated in this diagram, the drive controller 38 performs the following control in the image formation during normal printing.

When manipulation on the unshown manipulator allows the image forming apparatus 1 to perform the normal printing, the drive controller 38 operates the first switch SW1 to connect the phase-Z terminal 14z of the encoder 14 with the signal corrector 32. The drive controller 38 operates the second switch SW2 to connect the phase-A terminal 14a of the encoder 14 with the signal corrector 32. The drive controller 38 controls the selection circuit 36a so as to select the first clock signal input from the first clock signal generator 33. The drive controller 38 drives the driving roller 11 of the media transporting apparatus 1a to start transporting recording medium P.

The signal corrector 32 is thereby supplied with the phase-Z signal from the phase-Z terminal 14z and the phase-A signal from the phase-A terminal 14a of the encoder 14. The signal corrector 32 generates an increment address for the correction table stored in the storage 31 with reference to the input phase-Z signal, reads correction data from the correction table, and applies the correction data to the phase-A signal to generate a corrected phase-A signal. The generated corrected phase-A signal is output to the first clock signal generator 33.

The first clock signal generator 33 uses a passage signal for recording medium P input from the media passage sensor 1b as a trigger and outputs the corrected phase-A signal input from the signal corrector 32 as the first clock signal to the drive signal generator 36 at the timing when recording medium P reaches an ink discharge position in the ink supply apparatus 1c.

The drive signal generator 36 likewise supplies all head driving circuits including the first driving circuit 36-1 and the second driving circuit 36-2 with the first clock signal (corrected phase-A signal) input from the first clock signal generator 33. All the head driving circuits read image data from the image data generator 37 based on the first clock signal (corrected phase-A signal) input from the first clock signal generator 33. Each nozzle is supplied with a head drive signal corresponding to the read image data. The ink is discharged from each nozzle opening to print an image based on the read image data onto recording medium P.

### Formation of the Correction Value Detection Pattern

FIG. 6 is a block diagram illustrating the formation of the correction value detection pattern in the image forming apparatus 1 according to the embodiment. A dotted line represents a constituent element that does not function in the formation of the correction value detection pattern. As illustrated in this diagram, the drive controller 38 performs the following control in the formation of the correction value detection pattern.

When manipulation on the unshown manipulator allows the image forming apparatus 1 to form the correction value detection pattern, the drive controller 38 operates the first switch SW1 to connect the phase-Z terminal 14z of the encoder 14 with the second driving circuit 36-2. The drive controller 38 operates the second switch SW2 to connect the phase-A terminal 14a of the encoder 14 with the first clock signal generator 33. The drive controller 38 controls the selection circuit 36a so as to select the second clock signal input from the second clock signal generator 35. The drive controller 38 drives the driving roller 11 of the media transporting apparatus 1a to start transporting recording medium P.

The phase-A signal from the phase-A terminal 14a is thereby input to the first clock signal generator 33. The first clock signal generator 33 uses a passage signal for recording medium P input from the media passage sensor 1b as a trigger and outputs the phase-A signal directly input from the phase-A terminal 14a as the first clock signal to the first driving circuit 36-1 of the drive signal generator 36 at the timing when recording medium P reaches an ink discharge position in the ink supply apparatus 1c.

The first driving circuit 36-1 reads image data from the image data generator 37 corresponding to the first clock signal (phase-A signal) input from the first clock signal generator 33. The first driving circuit 36-1 supplies each nozzle of the first nozzle group 22-1 with a head drive signal corresponding to the read image data, allows each nozzle to discharge the ink from the nozzle opening, and prints an image based on the read image data onto recording medium P.

The phase-Z signal from the phase-Z terminal 14z is input to the marker generating circuit 36b of the second driving circuit 36-2. The marker generating circuit 36b generates a marker corresponding to the cycle of the phase-Z signal. Image data for the generated marker is output to the signal synthesizing circuit 36c.

The internal clock generator 34 outputs an internal clock signal to the second clock signal generator 35. The internal clock signal configures a pulse train similar to that of the design value for the phase-A signal. The second clock signal generator 35 uses a passage signal for recording medium P input from the media passage sensor 1b as a trigger and outputs the internal clock signal input from the internal clock generator 34 to the selection circuit 36a at the timing when recording medium P reaches an ink discharge position in the ink supply apparatus 1c. The internal clock signal is output as a second clock signal to the selection circuit 36a and is selected in the selection circuit 36a. The second clock signal selected by the selection circuit 36a reads image data from the image data generator 37.

The signal synthesizing circuit 36c then synthesizes the image data for the marker corresponding to the cycle of the phase-Z signal with the image data read from the image data generator 37.

The second driving circuit 36-2 supplies each nozzle of the second nozzle group 22-2 with a head drive signal corresponding to the image data synthesized in the signal synthesizing circuit 36c, allows each nozzle to discharge the ink from the nozzle opening, and prints an image based on the read image data onto recording medium P.

The drive controller 38 forms the correction value detection pattern by forming the above-described image until the marker generating circuit 36b generates at least two markers.

### Correction Value Detection Pattern

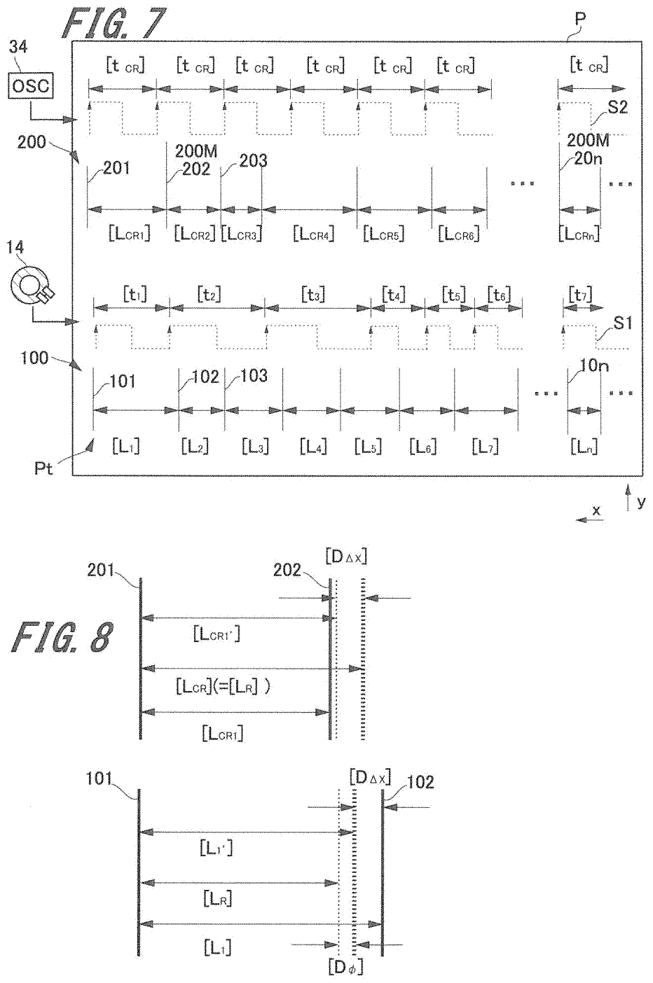

FIG. 7 is a diagram illustrating correction value detection pattern Pt used to explain the image forming method according to the embodiment. The diagram illustrates correction value detection pattern Pt formed by the above-described image forming apparatus 1 on recording medium P. In FIG. 7, a first clock signal S1 and a second clock signal S2 are shown in dotted lines. FIG. 8 is a diagram illustrating in detail correction value detection pattern Pt.

As illustrated in these diagrams, correction value detection pattern Pt formed on recording medium P includes a first chart 100 and a second chart 200. The first chart 100 and the second chart 200 each include a line pattern that is orthogonal to transportation direction x of recording medium P and is placed in transportation direction x. The first chart 100 and the second chart 200 are formed adjacently in a direction orthogonal to transportation direction x.

The first chart 100 is an image formed by the first nozzle group 22-1 (see FIG. 6) and includes a plurality of lines 101, 102, and so on formed based on first clock signal S1 comprised of the phase-A signal output from the encoder 14. The phase-A signal as first clock signal S1 is not corrected and therefore provides inconstant pulse cycles [t1], [t2], and so on and includes errors. Errors are also included in measured intervals [L₁], [L₂], and so on among the lines 101, 102, and so on with reference to a design interval [L_{R}]. The error is the sum of displacements [Dφ] and [DΔx]. Displacement [Dφ] cyclically occurs at ink landing positions resulting from an eccentricity component. Displacement [DΔx] irregularly occurs at ink landing positions resulting from a variation in the transportation speed.

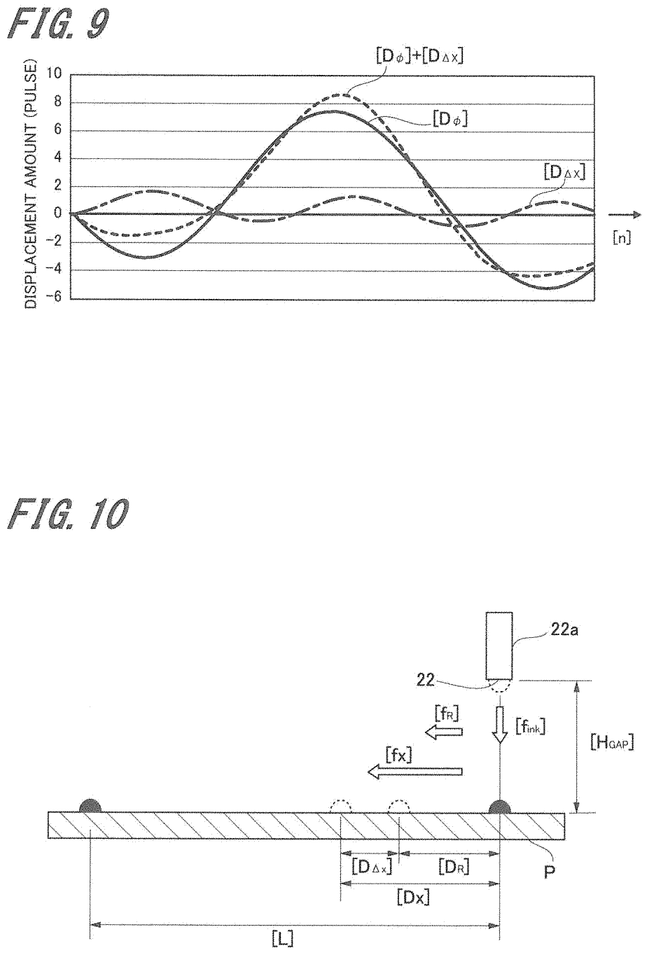

FIG. 9 is a graph illustrating the displacement amount of ink landing positions and applies to a case where the uncorrected phase-A signal is assumed to be first clock signal S1. As illustrated in FIG. 9, displacements [Dφ] and [DΔx] occur at ink landing positions. Displacement [Dφ] cyclically varies the displacement amount due to an eccentricity component of the media transporting apparatus 1a. Displacement [DΔx] irregularly occurs at ink landing positions resulting from a variation in the transportation speed. The sum of cyclic displacement [Dφ] and irregular displacement [DΔx] is contained in measured intervals [L₁], [L₂], and so on among the lines 101, 102, and so on in the first chart 100.

The second chart 200 is an image formed by the second nozzle group 22-2 (see FIG. 6) and includes a plurality of lines 201, 202, and so on formed based on second clock signal S2 comprised of the internal clock signal output from the internal clock generator 34. The second chart 200 includes at least two markers 200M. The marker 200M is shaped by extending the length of line 202, for example.

Second clock signal S2 as the internal clock signal is a pulse signal having a predetermined cycle [t_{CR}]. Therefore, measured intervals [L_{R1}], [L_{R2}], and so on among lines 201, 202, and so on include only displacement [DΔx] irregularly occurring at ink landing positions resulting from a variation in the transportation speed.

Therefore, correction value detection pattern Pt allows lines 101, 102, and so on comprising the first chart 100 and lines 201, 202, and so on comprising the second chart 200 to be placed at displaced positions so as to deviate from one straight line.

### Method of Generating the Correction Table

The description below explains a method of generating the correction table that uses correction value detection pattern Pt formed as above to correct a pulse interval in the phase-A signal output from the encoder 14.

According to the following method of generating the correction table, the image read sensor 41 reads correction value detection pattern Pt formed on recording medium P and outputs read image data to the calculator 42. The calculator 42 performs the method. The CPU comprising the calculator 42 generates the correction table by executing a program saved in the ROM or the RAM. A procedure executed by the calculator 42 to generate the correction table conforms to a program saved in the ROM or a program that is loaded from an external apparatus into the RAM and saved in the RAM. These programs configure a correction value calculating program executed by the calculator 42. The description below explains the correction table generation method performed by the calculator 42.

Pulse intervals in the phase-A signal output from the encoder 14 include a cyclic displacement resulting from the eccentricity component. This displacement equals cyclic displacement [Dφ] contained in measured intervals [L₁], [L₂], and so on among lines 101, 102, and so on comprising the first chart 100 in correction value detection pattern Pt.

In FIG. 8, when design interval [L_{R}] is contained among lines 101, 102, and so on formed based on the ideal phase-A signal containing no eccentricity component and correction-targeted interval [L₁] contains cyclic displacement [Dφ], the following equation (1) is used to find correction data [CR₁] between lines 101 and 102.

[Equation 1]

[CR₁]=[L_{R}]/[L₁′] Formula (1)

In equation (1), correction-targeted interval [L₁] is found by equation (2) as follows based on measured interval [L₁] between the corresponding lines 101 and 102 and irregular displacement [DΔx] at the ink landing position resulting from variation in the transportation speed described above.

[Equation 2]

[L_{1′}]=[L₁]−[D_{Δx}] Formula (2)

In equations (1) and (2), measured interval [L₁] and design interval [L_{R}] are already known. Correction data [CR₁] can be found by finding irregular displacement [DΔx]. Irregular displacement [DΔx] is found as follows.

FIG. 10 is a diagram illustrating irregular displacement [DΔx] of ink landing positions occurring due to a variation in transportation speeds. In this diagram, [H_{GAP}] denotes a gap between the opening of the ink discharge nozzle 22 and recording medium P. [fᵢₙₖ] denotes a flying speed of the ink. [f_{R}] denotes a standard transportation speed of recording medium P. [fx] denotes a speed of recording medium P. [D_{R}] denotes a distance traveled by recording medium P at the standard transportation speed [f_{R}] until an ink droplet lands on recording medium P after the ink discharge nozzle 22 discharges the ink. [Dx] denotes a distance traveled by recording medium P at the transportation speed [fx] until an ink droplet lands on recording medium P after the ink discharge nozzle 22 discharges the ink. In this case, irregular displacement [DΔx] is found by equation (3) as follows.

$$\begin{matrix} [ Equation 3 ] & \\ [ {D}_{Δ x} ] = [ {D}_{X} ] - [ {D}_{R} ] = [ {H}_{GAP} ] / [ {f}_{ink} ] \times [ {f}_{X} ] - [ {H}_{GAP} ] / [ {f}_{ink} ] \times [ {f}_{R} ] & Formula ( 3 )\end{matrix}$$

In equation (3), transportation speed [fx] is a factor to cause irregular displacement [DΔx]. The other values are already known design values. Transportation speed [fx] can be expressed as follows by using values among lines 201, 202, and so on configuring the second chart 200 illustrated in FIGS. 7 and 8 and the above-described design values. The method extracts an interval between lines 201 and 202 causing the largest overlap with an interval between lines 101 and 102 to calculate correction data [CR₁] in transportation direction x and uses values for the extracted interval between lines 201 and 202.

The measured interval [L_{CR1}] between extracted lines 201 and 202 is expressed by equation (4) as follows based on an assumed interval [L_{CR1}′] with gap [H_{GAP}] (see FIG. 10) assumed to be 0 and irregular displacement [DΔx] contained between lines 201 and 202.

[Equation 4]

[L_{CR1}]=[L_{CR1}′]+[D_{Δx}] Formula (4)

The second chart 200 is formed based on the second clock signal S2 at the specified cycle [t_{CR}] generated by the internal clock generator 34. When the transportation speed varies, the second chart 200 causes irregular displacement [DΔx] at the ink landing position resulting from the variation even if the gap [H_{GAP}] in FIG. 10 is 0. However, lines 201 and 202 extracted in the second chart 200 do not completely overlap with lines 101 and 102 in the first chart 100 targeted at calculating correction data [CR₁]. Irregular displacement [DΔx] contained between lines 201 and 202 does not equal irregular displacement [DΔx] between lines 101 and 102 configuring the first chart 100 but approximates the same.

When gap [H_{GAP}] is assumed to be 0, assumed interval [L_{CR1}′] can be expressed by equation (5) as follows based on design interval [L_{CR}] among lines 201, 202, and so on, standard transportation speed [f_{R}] of recording medium P, and transportation speed [fx] of recording medium P. Design interval [L_{CR}] among lines 201, 202, and so on equals design interval [L_{R}] among lines 101, 102, and so on

[Equation 5]

[L_{CR1}′]=[L_{CR}]×[fx]/[f_{R}] Formula (5)

Equation (4) can be rewritten to equation (6) as follows by assigning equation (5) containing transportation speed [fx] as above and equation (3) that contains transportation speed [fx] and expresses irregular displacement [DΔx].

$$\begin{matrix} [ Equation 6 ] & \\ [ {L}_{CR 1} ] = ( [ {L}_{CR} ] \times [ {f}_{X} ] / [ {f}_{R} ] ) + ( [ {H}_{GAP} ] / [ {f}_{ink} ] \times [ {f}_{X} ] ) - ( [ {H}_{GAP} ] / [ {f}_{ink} ] \times [ {f}_{R} ] ) = [ {f}_{X} ] ( [ {L}_{CR} ] / [ {f}_{R} ] + [ {H}_{GAP} ] / [ {f}_{ink} ] ) - ( [ {H}_{GAP} ] / [ {f}_{ink} ] \times [ {f}_{R} ] ) & Formula ( 6 )\end{matrix}$$

Equation (6) can be transformed to equation (7) that finds transportation speed [fx] as follows. Equation (7) expresses transportation speed [fx] by using only a measured value and a design value.

[Equation 7]

[fx]=([L_{CR1}]+[H_{GAP}]/[fx]×[f_{R}])/([L_{CR}]/[f_{R}]+[H_{GAP}]/[fᵢₙₖ]) Formula (7)

The calculator 42 uses the measured value and the design value configuring equation (7) and assigns the measured value and the design value to equation (7) to calculate transportation speed [fx] of recording medium P. The calculator 42 assigns the calculated transportation speed [fx] to equation (3) above to calculate irregular displacement [DΔx]. The calculator 42 assigns irregular displacement [DΔx] to equation (2) above to calculate correction-targeted interval [L₁′]. The calculator 42 assigns the calculated correction-targeted interval [L₁′] to equation (1) to find correction data [CR₁].

The calculator 42 calculates correction data [CR₁] among lines 101, 102, and so on configuring the first chart 100 by using the above-described equations (1) through (3) and (7) and generates a correction table containing the calculated correction data.

The calculator 42 successively selects intervals among lines 101, 102, and so on formed between the two markers 200M formed in the second chart 200. The calculator 42 then successively extracts intervals among lines 201, 202, and so on configuring the second chart 200 corresponding to intervals among lines 101, 102, and so on selected to calculate correction data [CR₁]. As above, the calculator 42 extracts the interval between lines 201 and 202 causing the largest overlap with the interval between lines 101 and 102 to calculate correction data [CR₁] in transportation direction x. The calculator 42 successively calculates correction values based on measured interval [L₁] between lines 101 and 102 selected from the first chart 100, measured interval [L_{CR1}] between lines 201 and 202 extracted from the second chart 200, and the above-described design values.

The calculator 42 or the control apparatus 1d previously includes design values such as design interval [L_{R}] among lines 101, 102, and so on included in equation (1), gap [H_{GAP}] included in equation (7), ink flying speed [fᵢₙₖ], standard transportation speed [f_{R}] of recording medium P, and design interval [L_{CR}] among lines 201, 202, and so on.

The calculator 42 detects measured intervals [L₁], [L₂], and so on among lines 101, 102, and so on included in equation (2) and measured intervals [L_{CR1}], [L_{CR2}], and so on among lines 201, 202, and so on included in equation (7) based on image data of correction value detection pattern Pt the image read sensor 41 reads from recording medium P.

When the calculator 42 is provided for the image forming apparatus 1, the drive controller 38 allows the storage 31 to store the correction table generated by the calculator 42. When the storage 31 already stores the correction table, the correction table stored in the storage 31 is updated to the correction table newly calculated by the calculator 42.

When the calculator 42 is provided for an external apparatus outside the image forming apparatus 1, manipulation on an unshown manipulator stores the correction table generated by the calculator 42 in the storage 31. When the storage 31 already stores the correction table, the correction table stored in the storage 31 is updated to the correction table newly calculated by the calculator 42.

### Effects of the Embodiment

The image forming apparatus 1, the image forming method, and the image forming program according to the above-described embodiment can eliminate an irregular displacement resulting from a variation in the transportation speed of the media transporting apparatus 1a and accurately correct an ink landing displacement cyclically occurring due to an eccentricity component of the media transporting apparatus 1a. This makes it possible to highly accurately form images.

FIG. 11 is a correction table generated by the calculator 42 to correct signals based on the encoder. The correction table in this diagram shows a phase reverse to cyclic displacement [Dφ] at an ink landing position resulting from the eccentricity component illustrated in FIG. 9 and eliminates the effect of irregular displacement [DΔx] at an ink landing position resulting from a variation in the transportation speed. This correction table is used to correct the phase-A signal output from the phase-A terminal 14a of the encoder 14 with reference to the phase-Z signal output from the phase-Z terminal 14z of the encoder 14, to thereby generate the corrected phase-A signal that is already subject to the eccentricity correction to highly accurately eliminate the eccentricity component.

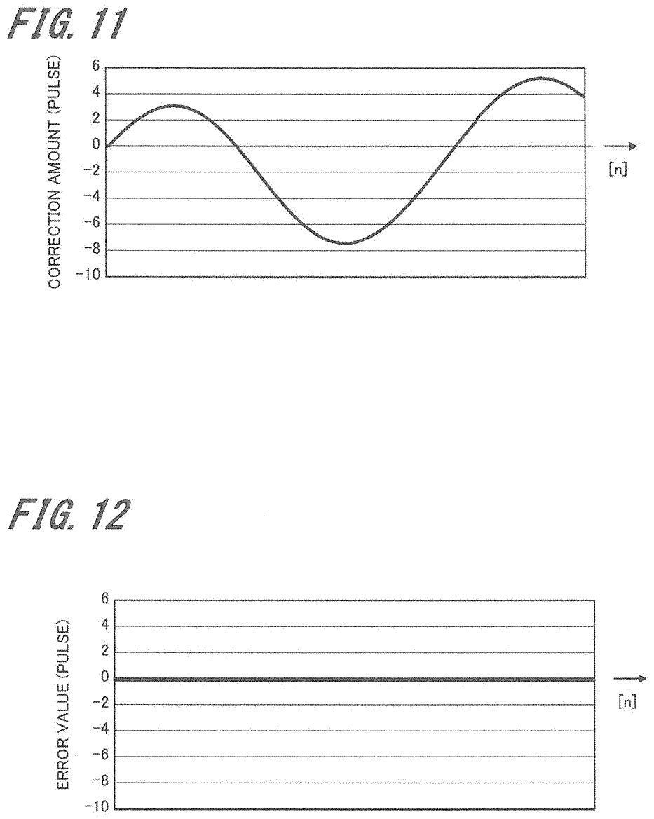

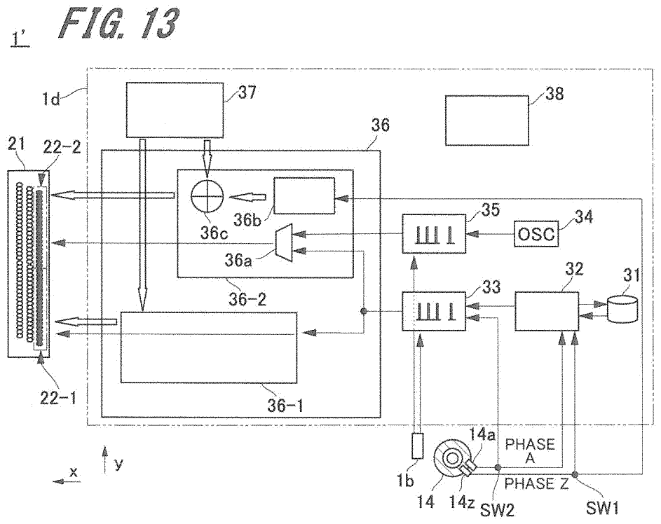

FIG. 12 is a diagram illustrating displacement of the correction signal that is already subject to the eccentricity correction. The correction table in FIG. 11 is used to correct the phase-A signal output from the phase-A terminal 14a of the encoder 14 with reference to the phase-Z signal output from the phase-Z terminal 14z of the encoder 14. The diagram illustrates the displacement of the corrected phase-A signal. As illustrated in this diagram, the corrected phase-A signal is available as a displacement-free clock signal void of the effect of irregular displacement [DΔx]. As a result, the corrected phase-A signal is used as the first clock signal, making it possible to form highly accurate images.

Correction value detection pattern Pt according to the present embodiment includes lines 101, 102, and so on based on the phase-A signal output from the encoder 14 and lines 201, 202, and so on based on the internal clock signal at specified cycle [t_{CR}] output from the internal clock generator 34. As above, it is possible to acquire the correction table that eliminates an irregular displacement and accurately corrects only a cyclically occurring ink landing displacement.

Therefore, it is possible to perform the accurate correction as above without generating and averaging a plurality of correction value detection patterns and improve the working efficiency to correct the first clock signal. It is also possible to minimize the use of recording medium P in order to form the correction value detection pattern and reduce costs of operating the image forming apparatus 1.

### First Modification

FIG. 13 is a block diagram illustrating a first modification of the embodiment. An image forming apparatus 1′ according to the first modification differs from the image forming apparatus 1 according to the embodiment in that the first nozzle group 22-1 and the second nozzle group 22-2 are provided for the same ink head 21. The other configurations are similar to those of the image forming apparatus 1 according to the embodiment. In the image forming apparatus 1′ according to the first modification, one ink head 21 favorably includes the ink discharge nozzles 22 that are placed on the same straight line extending in placement direction y and are divided into the first nozzle group 22-1 and the second nozzle group 22-2 approximately at the center of placement direction y.

The configuration of the first modification enables an image formed by the first nozzle group 22-1 based on the phase-A signal output from the encoder 14 as the first clock signal S1 and an image formed by the second nozzle group 22-2 based on the internal clock signal output from the internal clock generator 34 as the second clock signal S2 to be formed as closely as possible.

The image forming apparatus 1′ according to the first modification can provide the correction table capable of more accurately correcting cyclic displacement [Dφ] than the correction table generated based on the correction value detection pattern formed by the image forming apparatus 1 according to the embodiment. The result is to be capable of more accurately forming images.

### Second Modification

The above-described embodiment uses the internal clock signal at a specified cycle [t_{CR}] output from the internal clock generator 34 as the first clock signal for the ink from the second nozzle group 22-2. However, another example of the first clock signal for the ink from the second nozzle group 22-2 may be provided as a delay signal occurring after a lapse of specified time from the phase-A signal output from the phase-A terminal 14a of the encoder 14.

In this case, the internal clock generator 34 is provided with a delay signal generator that generates a delay signal occurring after a lapse of specified time from the phase-A signal. When the correction value detection pattern is formed, the phase-A terminal 14a of the encoder 14 inputs the phase-A signal to the delay signal generator. The internal clock generator 34 thereby outputs a second clock signal that ensures a specified interval from the phase-A signal.

In this case, the delay time at a specified interval is assumed to be the internal clock signal at a specified cycle. An interval comparable to the delay time is extracted from intervals among lines 201, 202, and so on configuring the second chart 200. Measured intervals [L_{CR1}], [L_{CR2}], and so on among lines 201, 202, and so on may be provided by adding design interval [L_{CR}] among lines 201, 202, and so on to the extracted intervals. This makes it possible to generate the correction table similarly to the above-described method and provide effects similar to the embodiment.

### Third Modification

The above-described embodiment has explained the media transporting apparatus 1a as a belt transporting apparatus. However, the media transporting apparatus 1a may be provided as a drum-type transporting apparatus and can provide similar effects by similarly using the configurations of the embodiment.

### Fourth Modification

As a modification of the embodiment, the ink supply apparatus 1c may be capable of freely varying the gap [Hgap], namely, a height with reference to recording medium P transported by the media transporting apparatus 1a. When correction value detection pattern Pt is formed, the ink head 21 provided with the ink discharge nozzle 22 of the second nozzle group 22-2 needs to be higher than the ink head 21 provided with the ink discharge nozzle 22 of the first nozzle group 22-1.

This increases an error occurring in the second chart 200 of correction value detection pattern Pt, making it possible to easily detect irregular displacement [DΔx].

### Fifth Modification

According to the above-described embodiment, correction value detection pattern Pt is formed by inputting the phase-Z signal to the second driving circuit 36-2 and forming the marker 200M in the second chart 200. However, a marker corresponding to the phase-Z signal may be formed in the first chart 100. In this case, the first driving circuit 36-1 is provided with the marker generating circuit 36b and the signal synthesizing circuit 36c. When correction value detection pattern Pt is formed, the phase-Z signal is input to the first driving circuit 36-1.

The image data generator 37 may generate a marker. In this case, the image data generator 37 is provided with the marker generating circuit 36b and the signal synthesizing circuit 36c. When correction value detection pattern Pt is formed, the phase-Z signal is input to the image data generator 37. The marker can be thereby formed in at least one of the first chart 100 and the second chart 200.

Although embodiments of the present invention have been described and illustrated in detail, the disclosed embodiments are made for purposes of illustration and example only and not limitation The scope of the present invention should be interpreted by terms of the appended claims

### REFERENCE SIGNS LIST

1, 1′—image forming apparatus

1a—media transporting apparatus

1b—media passage sensor

1c—ink supply apparatus

14—encoder

14a—phase-A terminal (pulse signal)

21—ink head

22—ink discharge nozzle

22-1—first nozzle group

22-2—second nozzle group

32—signal corrector

33—first clock signal generator

34—internal clock generator

35—second clock signal generator

36—drive signal generator

36-1—first driving circuit

36-2—second driving circuit

36a—selection circuit

38—drive controller

41—image read sensor

42—calculator

100—first chart

101, 102,—line

200—second chart

201, 202,—line

S1—first clock signal

S2—second clock signal

SW1—first switch

SW2—second switch

P—recording medium

Pt—correction value detection pattern

x—transportation direction

y—placement direction (vertical direction)

[H_{GAP}]—gap (design value)

[fᵢₙₖ]—ink flying speed (design value)

[f_{R}]—standard transportation speed (design value) of a recording medium

[fx]—transportation speed

[L_{R}]—design interval (design value) among lines 101, 102, and so on

[L_{CR}]—design interval (design value) among lines 201, 202, and so on

[L₁], [L₂],—measured interval among lines 101, 102, and so on

[L_{CR1}], [L_{CR2}],—measured interval among lines 201, 202, and so on

1. An image forming apparatus comprising:
a media transporting apparatus that transports a recording medium;
an ink supply apparatus that includes a plurality of ink discharge nozzles in a direction orthogonal to a transportation direction of the recording medium transported by the media transporting apparatus;
an encoder that is provided for the media transporting apparatus in order to detect a transport amount of the recording medium and acquire a pulse signal as a reference of ink discharge from the ink discharge nozzle;
a first clock signal generator that outputs a pulse signal output from the encoder as a first clock signal at a timing corresponding to transportation of the recording medium;
a second clock signal generator that outputs a pulse signal having a specified interval as a second clock signal at a timing corresponding to transportation of the recording medium; and
a drive signal generator that, generates a drive signal to control discharge of ink from the ink discharge nozzle,
wherein the drive signal generator includes a first driving circuit and a second driving circuit to generate a drive signal in order to control discharge of ink from ink discharge nozzles in a first nozzle group and a second nozzle group independently of each other on a group basis, the first nozzle group and the second nozzle group being provided by dividing a placement of ink discharge nozzles into two in a direction orthogonal to a transportation direction of the recording medium;
wherein the first driving circuit generates a drive signal that discharges ink from an ink discharge nozzle in the first nozzle group at an interval of the first clock signal;
wherein the second driving circuit generates a drive signal that discharges ink from an ink discharge nozzle in the second nozzle group at an interval of the second clock signal; and
wherein the ink supply apparatus forms a correction value detection pattern on the recording medium transported by the media transporting apparatus, the correction value detection pattern including a first chart having lines placed at an interval of the first clock signal and a second chart having lines placed at an interval of the second clock signal according to ink discharge from ink discharge nozzles in the first nozzle group and the second nozzle group based on the drive signal generated from the first driving circuit and the second driving circuit.

2. The image forming apparatus according to claim 1,
wherein an ink discharge nozzle in the first nozzle group and an ink discharge nozzle in the second nozzle group are placed on the same straight line orthogonal to a transportation direction of the recording medium.

3. The image forming apparatus according to claim 1, comprising:
an image read sensor that reads the correction value detection pattern formed on the recording medium; and
a calculator that calculates a correction value in order to correct a pulse signal input from the encoder to the first clock signal generator based on the correction value detection pattern read by the image read sensor.

4. The image forming apparatus according to claim 3,
wherein the calculator calculates the correction value by performing a process that eliminates a variation component in a transportation speed of the recording medium transported by the media transporting apparatus from a line interval of the first chart based on a line interval of the first chart and a line interval of the second chart read by image read sensor and based on a design value used to calculate an ink landing position on the recording medium, the ink being discharged from the ink discharge nozzle.

5. The image forming apparatus according to claim 4,
wherein the calculator successively selects a line interval used to calculate the correction value out of a plurality of line intervals configuring the first chart, extracts a line interval causing the largest overlap with the selected line interval in the transportation direction out of a plurality of line intervals configuring the second chart, and successively calculates the correction value.

6. The image forming apparatus according to claim 1, further comprising:
a signal corrector that corrects a pulse signal output from the encoder based on a correction value calculated from the correction value detection pattern and outputs the pulse signal to the first clock signal generator;
a switch that switches input of a pulse signal output from the encoder between the first clock signal generator and the signal corrector; and
a drive controller that controls driving of the switch,
wherein the drive controller controls switching of the switch so that a pulse signal output from the encoder is input to the first clock signal generator in case of forming the correction value detection pattern based on ink discharge from the ink discharge nozzle and a pulse signal output from the encoder is input to the signal corrector in case of forming a normal image.

7. The image forming apparatus according to claim 1,
wherein the second driving circuit includes a selection circuit that is connected to the first clock signal generator and the second clock signal generator and selects one of a first clock signal output from the first clock signal generator and a second clock signal output from the second clock signal generator;
wherein the selection circuit selects the second clock signal in case of forming the correction value detection pattern based on ink discharge from the ink discharge nozzle and selects the first clock signal in case of forming a normal image; and
wherein the second driving circuit generates a drive signal synchronized with a signal selected in the selection circuit.

8. The image forming apparatus according to claim 1,
wherein the ink supply apparatus includes a plurality of ink heads including the ink discharge nozzle and an ink discharge nozzle in the first nozzle group and an ink discharge nozzle in the second nozzle group are provided for an ink head adjacently placed in a direction orthogonal to a transportation direction of the recording medium and are placed on the same straight line.

9. The image forming apparatus according to claim 8,
wherein the ink supply apparatus freely changes a height with reference to the recording medium transported by the media transporting apparatus and, when forming the correction value detection pattern, positions an ink head provided with an ink discharge nozzle in the second nozzle group so as to he higher than an ink head provided with an ink discharge nozzle in the first nozzle group.

10. The image forming apparatus according to claim 1, further comprising:
an internal clock generator that oscillates an internal clock signal at a specified interval equal to a design value for a pulse signal output from the encoder,
wherein the second clock signal generator outputs the internal clock signal as a second clock signal timed to coincide with transportation of the recording medium.

11. The image forming apparatus according to claim 1,
wherein the second clock signal generator outputs second clock signal delayed at a specified interval with reference to a first clock signal output from the first clock signal generator.

12. The image forming apparatus according to claim 1,
wherein the media transporting apparatus is available as one of a belt type and a drum type.

13. An image forming method using an image forming apparatus including:
a media transporting apparatus that transports a recording medium;
an ink supply apparatus that includes a plurality of ink discharge nozzles in a direction orthogonal to a transportation direction of the recording medium transported by the media transporting apparatus;
an encoder that is provided for the media transporting apparatus in order to detect a transport amount of the recording medium and acquire a pulse signal as a reference of ink discharge from the ink discharge nozzle;
a first clock signal generator that outputs a pulse signal output from the encoder as a first clock signal at a timing corresponding to transportation of the recording medium;
a second clock signal generator that outputs a pulse signal having a specified interval as a second clock signal at a timing corresponding to transportation of the recording medium; and
a drive signal generator that generates a drive signal to control discharge of ink from the ink discharge nozzle,
wherein the drive signal generator includes a first driving circuit and a second driving circuit to generate a drive signal in order to control discharge of ink from ink discharge nozzles in a first nozzle group and a second nozzle group independently of each other on a group basis, the first nozzle group and the second nozzle group being provided by dividing a placement of ink discharge nozzles into two in a direction orthogonal to a transportation direction of the recording medium;
wherein the first driving circuit generates a drive signal that discharges ink from an ink discharge nozzle in the first nozzle group at an interval of the first clock signal;
wherein the second driving circuit generates a drive signal that discharges ink from an ink discharge nozzle in the second nozzle group at an interval of the second clock signal; and
wherein the ink supply apparatus forms a correction value detection pattern on the recording medium transported by the media transporting apparatus, the correction value detection pattern including a first chart having lines placed at an interval of the first clock signal and a second chart having lines placed at an interval of the second clock signal according to ink discharge from ink discharge nozzles in the first nozzle group and the second nozzle group based on the drive signal generated from the first driving circuit and the second driving circuit.

14. A correction value calculating program that calculates a correction value to correct a pulse signal input from the encoder to the first clock signal generator based on a correction value detection pattern formed by an image forming apparatus according to claim 1,
wherein the correction value calculating program calculates the correction value by executing a process that eliminates a variation component in a transportation speed of the recording medium transported by the media transporting apparatus from a line interval of the first chart based on a line interval of the first chart and a line interval of the second chart in the correction value detection pattern and based on a design value used to calculate an ink landing position on the recording medium, the ink being discharged from the ink discharge nozzle.

15. The correction value calculating program according to claim 14 that successively selects a line interval used to calculate the correction value out of a plurality of line intervals configuring the first chart, extracts a line interval causing the largest overlap with the selected line interval in a transportation direction out of a plurality of line intervals configuring the second chart, and successively calculates the correction value.

16. A correction value detection pattern formed by the image forming apparatus according to claim 1.
